(19) United States
(12) Patent Application Publication
(10) Pub. No.: US 2025/0296304 A1
(43) Pub. Date: Sep. 25, 2025

(54) MULTILAYER HEAT-SEAL FILM

(71) Applicant: Dow Global Technologies LLC, Midland, MI (US)

(72) Inventors: Gianna Buaszczyk, Sao Paulo (BR); Jorge Caminero Gomes, Sao Paulo (BR); Bruno Cesar De Moraes Barbosa, Sao Paulo (BR)

(21) Appl. No.: 18/861,615

(22) PCT Filed: Jun. 1, 2023
(86) PCT No.: PCT/US23/67734

§ 371 Date: Oct. 30, 2024

Related U.S. Application Data
(60) Provisional application No. 63/366,536, filed on Jun. 17, 2022.

(51) Int. Cl. B32B 27/08; B29C 48/00; B29C 48/21; B29K 23/00; B32B 27/32; C08J 3/22; C08J 7/052

(52) U.S. Cl. CPC B32B 27/08; B29C 48/022; B29C 48/21; B32B 27/32; B29K 2023/0625; B29K 2995/0089; B32B 2250/02; B32B 2250/03; B32B 2250/242; B32B 2307/31; B32B 2307/558; C08J 3/226; C08J 7/052

(57) ABSTRACT

Provided herein are multilayer films including linear low-density polyethylene (LLDPE), and a process for making the same. In some embodiments, the multilayer film includes a primary layer comprising an extruded first LLDPE composition, and a second layer including a polymer composition. The process for making the multilayer films according to embodiments disclosed herein includes melting a first LLDPE composition and a polymer composition, wherein prior to extrusion, the first LLDPE composition comprises a first LLDPE polymer and a free radical generator. The multilayer films can have desirable tear, heat seal, puncture, and dart drop properties as a result of being formed from the first LLDPE composition, including the free-radical generator, that acts as a rheology modifier.

### FIELD

This application relates to multilayer polymer films containing linear low-density polyethylene.

### INTRODUCTION

Polyethylene polymers and copolymers are commonly divided into the groups high density polyethylene (HDPE), which usually has a density around 0.93 g/cm³ to 0.98 g/cm³; low density polyethylene (LDPE), which usually has a density around 0.91 g/cm³ to 0.93 g/cm³; and linear low density polyethylene (LLDPE), which usually has a density around 0.91 g/cm³ to 0.94 g/cm³. Linear low-density polyethylenes contain short-chain branching and less long chain branching than LDPE and include the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045).

LLDPE is frequently coextruded with similar or dissimilar polymers to produce multilayer films. In coextrusion, two or more extruders each melt a different polymer and feed the polymers to a single extrusion die. The polymers are extruded together to form a film that contains one or more layers of each polymer, with the layers adhered together. The multilayer film may contain a first or primary layer comprising LLDPE polymer selected to provide desired physical properties, such as tensile strength, puncture resistance and tear resistance. Other layers in the multilayer films can be selected to provide other desired properties, such as improved heat-seal performance, appearance, stiffness, adhesion between layers and/or barrier to migration of water, oxygen or flavor components.

Multilayer films are frequently used in form, fill and seal (FFS) packaging to put goods in a sealed pouch made of the film. In summary, the FFS packaging process typically comprises the following steps:
1. Film is unrolled off a roll and proceeds in a machine direction.
2. The film is folded to bring the outside edges together, and the edges are welded together with heat and pressure to form a hollow tube with a seam running in the machine direction.
3. A heated set of jaws pinch the tube with heat and pressure transverse to the machine direction, to form a seal transverse to the machine direction. This forms a pouch with an open end in the upstream direction.
4. The pouch is filled with product from the open end.
5. A heated set of jaws pinch the open end of the pouch with heat and pressure transverse to the machine direction, to form a second seal transverse to the machine direction, with the product trapped in a pouch between the two seals.
6. The closed pouch is cut from the end of the tube.
   Form, fill and seal systems can be vertical (VFFS) or horizontal (HFFS). FFS packaging places severe demands on the film used to make it. The film must be flexible enough to easily fold to form the pouch, but strong enough to survive handling and stress on numerous occasions during boxing, shipping, storage and display. The film must seal quickly and completely, without gaps and voids. The seal must be strong enough to hold product in the pouch before the seal is completely cool, and the pouch closure must remain strong throughout the life of the packaging. The film must provide effective sealing on different equipment that has different temperature control capabilities. Ideally, these demands can be met while making the film as thin as possible in order to minimize the cost, weight and waste arising from the packaging.

Heat sealing can weaken the primary layer of a film in areas adjacent to the seal. The heated jaws that form the heat seal inadvertently soften the primary layer when they soften the heat seal layer. The process of moving the film line and filling the pouch exerts stress on the heated film. Stress on the heated primary layer causes it to become thinner in the areas adjacent to the heat seal. After the film cools and the stress is released, the primary layer remains thin and weak near the seal, as compared to the rest of the pouch. The pouch is susceptible to splitting and tearing near the seal.

One solution to minimize thinning of the primary layer is to add 20% or more of low density polyethylene to the LLDPE polymer used in the primary layer. However, LDPE increases the die pressure of the primary layer polymers, reducing their processability.

It would be desirable to reduce thinning in the primary layer without reducing the processability of polymers in other layers.

### SUMMARY

One aspect of the present invention is a process to make a multilayer film comprising the steps of (1) melting in separate extruders (a) a first LLDPE composition and (b) a polymer composition; and (2) coextruding the first LLDPE composition and the polymer composition under conditions suitable to form a multilayer film comprising a primary layer comprising an extruded LLDPE composition derived from the first LLDPE composition and a second layer comprising the polymer composition, and wherein
a) prior to extrusion, the first LLDPE composition comprises (i) at least 85 weight percent of a first LLDPE polymer that comprises at least 0.20 vinyl groups per 1000 carbon atoms; and (ii) from 5 to 1000 parts-per-million-by-weight (ppmw) of a free-radical generator; and
b) conditions in the extruder are suitable to substantially decompose the free-radical generator. “Substantially decompose” means that at least 80 weight percent of the free-radical generator decomposes under the reaction conditions during extrusion; in some embodiments at least 90 weight percent decompose or at least 95 weight percent or at least 99 weight percent. In some embodiments, the free-radical generator is at an indetectable level after the extrusion is completed. The “primary layer” in the multilayer film may also be called a “first layer”.

A second aspect of the present invention is a multilayer film made by the process of the first aspect of the present invention.

A third aspect of the present invention is a multilayer film comprising:
a) A primary layer comprising an extruded first LLDPE composition that comprises at least 85 weight percent of a first LLDPE polymer, wherein the extruded first LLDPE composition has (1) a complex viscosity ratio (η_{0.1}/η₁₀) of at least 1.7, for complex viscosity measured at 190° C. and at an angular frequency of 0.1 rad/s and at 10 rad/s; and (2) a ratio (Mz_{Abs}/Mw_{Abs}) from 2.9 to 4.0; and
b) A second layer comprising a polymer composition.

A fourth aspect of the present invention is a process to use the multilayer film in the second or third aspect, wherein the multilayer film is used in a form, fill and seal packaging process.

A fifth aspect of the present invention is a sealed package made by the process in the fourth aspect of the invention.

Without intending to be bound by theory, the free-radical generator in the first LLDPE composition increases the complex viscosity ratio of the extruded first LLDPE composition by inducing a small increase in long chain branching. The increased complex viscosity ratio means that the extruded first LLDPE composition has substantially higher viscosity under low shear conditions that exist during heat sealing on the FFS line, but not substantially higher viscosity under high shear conditions that exist in the extrusion die. The higher viscosity on the FFS line allows the extruded first LLDPE composition to better resist thinning and weakness during the heat seal process. The lower viscosity in the extrusion die allows the first LLDPE composition to retain good processability. In addition, in some embodiments, multilayer films of the present invention have improved puncture resistance and dart-drop results.

### BRIEF DESCRIPTION OF THE DRAWINGS

FIG. 1 depicts the results of seal strength tests for heat seals made at a series of increasing temperatures using two inventive films and a comparative film.

FIG. 2 depicts the results of hot tack tests for heat seals made at a series of increasing temperatures using two inventive films and a comparative film.

### DETAILED DESCRIPTION

### First LLDPE Composition

This invention uses a first LLDPE composition that comprises a first LLDPE polymer and a free-radical generator. In some embodiments, the first LLDPE polymer may be a blend of LLDPE polymers that collectively meet the criteria stated herein, and in some embodiments the first LLDPE polymer is a single LLDPE polymer that meets the criteria stated herein. The phrase “first LLDPE polymer” covers both embodiments. In some embodiments, the first LLDPE composition further comprises other polyethylene polymers, such as a carrier resin used in a masterbatch with the free-radical generator, as described later.

The first LLDPE polymer has a density from 0.91 g/cm³ to 0.94 g/cm³. Prior to extrusion, it has at least 0.20 vinyl groups per 1000 carbon atoms.

In some embodiments, the first LLDPE polymer is a copolymer in which at least 70 weight percent of the polymer is derived from ethylene monomer and at least 2 weight percent of the polymer is derived from one or more comonomers. Examples of suitable comonomers may include alpha-olefins. Suitable alpha-olefins may include those containing from 3 to 20 carbon atoms (C₃-C₂₀). For example, the alpha-olefin may be a C₄-C₂₀ alpha-olefin, a C₄-C₁₂ alpha-olefin, a C₃-C₁₀ alpha-olefin, a C₃-C₈ alpha-olefin, a C₄-C₅ alpha-olefin, or a C₆-C₈ alpha-olefin. In some embodiments, the alpha-olefin is selected from the group consisting of propylene, 1-butene, 1-pentene, 1-hexene, 4-methyl-1-pentene, 1-heptene, 1-octene, 1-nonene and 1-decene. In other embodiments, the alpha-olefin is selected from the group consisting of propylene, 1-butene, 1-hexene, and 1-octene. In further embodiments, the alpha-olefin is selected from the group consisting of 1-hexene and 1-octene.

In some embodiments, repeating units derived from ethylene make up at least 80%, or at least 90%, or at least 92%, by weight, of the first LLDPE polymer. In some embodiments, repeating units derived from ethylene make up or at most 98%, or at most 96%, or at most 94%, or at most 93%, by weight, of the first LLDPE polymer. In some embodiments, repeating units derived from alpha-olefin make up at most 20% by weight, of the first LLDPE polymer or at most 18%, or at most 15%, or at most 12%, or at most 10%, or at most 8%. In some embodiments, repeating units derived from alpha-olefin comonomers make up at least 2%, by weight, of the first LLDPE polymer or at least 4% or at least 6% or at least 7%.

Comonomer content is sometimes expressed in terms of short chain branches per 1000 carbon atoms, wherein the short chain branches are the residue of comonomers and contain no more than 18 carbon atoms or no more than 10 carbon atoms or no more than 6 carbon atoms.

In some embodiments, the first LLDPE polymer has at least 2 short chain branches per 1000 carbon atoms, or at least 5 or at least 7 or at least 9. In some embodiments, the first LLDPE polymer has at most 20 short chain branches per 1000 carbon atoms, or at most 18 or at most 15 or at most 13 or at most 11.

In some embodiments, the first LLDPE polymer may be homogeneously branched or heterogeneously branched. Long-chain branches contain at least 20 carbon atoms. In some embodiments, the first LLDPE polymer contains no more than 3 long-chain branches per 1000 carbon atoms, or no more than 2 or no more than 1. In some embodiments, the first LLDPE polymer is substantially linear, except for short-chain branches resulting from comonomers (essentially 0 long-chain branches per 1000 carbon atoms).

The first LLDPE polymer has a density from 0.90 g/cm³ to 0.94 g/cm³. All individual values and subranges of 0.90 g/cm³ to 0.94 g/cm³ are included and disclosed herein. For example, in some embodiments, the density ranges from a lower limit of 0.900, 0.905 0.910, 0.915, 0.920, 0.925, 0.930 or 0.935 g/cm³ to an upper limit of 0.940, 0.935, 0.930, 0.925, or 0.920 g/cm³.

Before it is coextruded, the first LLDPE polymer has at least 0.20 vinyl groups per 1000 carbon atoms. All individual values and subranges of at least 0.20 vinyl groups per 1000 carbon atoms are included and disclosed herein. For example, in some embodiments, the first LLDPE polymer has at least 0.20, 0.25, 0.30, or 0.35 vinyl groups per 1000 carbon atoms. In other embodiments, the first LLDPE polymer has at most 1.00 vinyl groups per 1000 carbon atoms or 0.70 vinyl groups per 1000 carbon atoms, or 0.65 vinyl groups per 1000 carbon atoms, or 0.60 vinyl groups per 1000 carbon atoms, or 0.55 vinyl groups per 1000 carbon atoms, or 0.50 vinyl groups per 1000 carbon atoms, or 0.45 vinyl groups per 1000 carbon atoms.

In some embodiments, the melt index (I₂) of the first LLDPE polymer ranges from 0.01 g/10 min to 30 g/10 min. All individual values and subranges of 0.01 g/10 min to 30 g/10 min are included and disclosed herein. For example, in some embodiments, the melt index (I₂) ranges from a lower limit of 0.01, 0.05, 0.1, 0.25, 0.5, 1, 3, 5, 7, 10, 12, 15, 18, 20, 23, or 25 to an upper limit of 30, 27, 25, 22, 20, 17, 15, 12, 10, 8, 5, 2, 1, 0.9, 0.7, or 0.5.

In some embodiments, the first LLDPE polymer has a weight average molecular weight (Mw_{Abs}) before extrusion of at least 80,000 Da or at least 100,000 Da or at least 120,000 Da. (All molecular weights are based on absolute molecular weight measurements.) In some embodiments, the first LLDPE polymer has a weight average molecular weight (Mw_{Abs}) before extrusion of at most 200,000 Da or at most 160,000 Da or at most 130,000 Da.

In some embodiments, the first LLDPE polymer has a molecular weight distribution before extrusion (Mw_{Abs}/Mn_{Abs}) of at least 3 or at least 3.5 or at least 4. In some embodiments, the first LLDPE polymer has a molecular weight distribution (Mw/Mn) before extrusion of at most 6 or at most 5 or at most 4.5.

In some embodiments, before extrusion, the ratio of Mz_{Abs}/Mw_{Abs} for the first LLDPE polymer is at least 2 or at least 2.5 or at least 2.75. In some embodiments, before extrusion, the ratio of Mz_{Abs}/Mw_{Abs} for the first LLDPE polymer is at most 4 or at most 3.5 or at most 3.25 or at most 3 or at most 2.9.

In some embodiments, before extrusion, the first LLDPE polymer has a complex viscosity (η₁₀) of no more than 6000 Pa-s or no more than 5000 Pa-s or no more than 4900 Pa-s or no more than 4800 Pa-s or no more than 4700 Pa-s, at a temperature of 190° C. and an angular frequency of 10 rad/s. In some embodiments, before extrusion, the first LLDPE polymer has a complex viscosity (η₁₀) of at least 4000 Pa-s or at least 4250 Pa-s or at least 4500 Pa-s, at a temperature of 190° C. and an angular frequency of 10 rad/s.

In some embodiments, before extrusion, the first LLDPE polymer has a complex viscosity (η_{0.1}) of no more than 9000 Pa-s or no more than 8000 Pa-s or no more than 7800 Pa-s or no more than 7600 Pa-s, at a temperature of 190° C. and an angular frequency of 0.1 rad/s. In some embodiments, before extrusion, the first LLDPE polymer has a complex viscosity (η_{0.1}) of at least 5000 Pa-s or at least 6000 Pa-s or at least 7000 Pa-s, at a temperature of 190° C. and an angular frequency of 0.1 rad/s.

Polyethylene polymers can be characterized by complex viscosity ratio (η_{0.1}/η₁₀), which is ratio of complex viscosity measured at an angular frequency of 0.1 rad/s and at 10 rad/s and a temperature of 190° C. In some embodiments, before extrusion, the first LLDPE polymer has a complex viscosity ratio (η_{0.1}/η₁₀) of no more than 2.5 or no more than 2.25 or no more than 2 or no more than 1.9 or no more than 1.8 or no more than 1.75 or no more than 1.7. In some embodiments, the first LLDPE polymer has a complex viscosity ratio (η_{0.1}/η₁₀) of at least 1.5.

Examples of suitable LLDPE polymers that are commercially available from The Dow Chemical Company include polymers sold under the trademark DOWLEX™ TG2085B, DOWLEX™ GM8051, ELITE™ 5401G, ELITE™ NG5401B, ELITE™ XB 81844.38 and ELITE™ AT 6501.

The first LLDPE polymer can be made via gas-phase, solution-phase, or slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof. In some embodiments, gas or slurry phase reactors are used. Suitable first LLDPE polymers may be produced according to the processes described at pages 15-17 and 20-22 in WO 2005/111291 A1. The catalysts used to make the first LLDPE polymers described herein may include Ziegler-Natta, chrome, metallocene, constrained geometry, or single site catalysts. In some embodiments, the first polyethylene polymer may be a unimodal LLDPE prepared using a single stage polymerization, e.g., slurry, solution, or gas phase polymerization. In other embodiments, the first LLDPE polymer may be a unimodal LLDPE prepared in a loop reactor, for example, in a single stage loop polymerization process. Loop reactor processes are further described in WO/2006/045501 or WO2008104371. Multimodal (e.g., bimodal) polymers can be made by mechanical blending of two or more separately prepared polymer components or prepared in-situ in a multistage polymerization process or both. In some embodiments, the first LLDPE polymer may be a multimodal LLDPE prepared in-situ in a multistage, i.e., two or more stage, polymerization or by the use of one or more different polymerization catalysts, including single-, multi- or dual site catalysts, in a one stage polymerization. For example, the first LLDPE polymer may be a multimodal LLDPE produced in at least two-stage polymerization using the same catalyst, for e.g., a single site or Ziegler-Natta catalyst, as disclosed in U.S. Pat. No. 8,372,931. Thus, for example two solution reactors, two slurry reactors, two gas phase reactors, or any combinations thereof, in any order can be employed, such as disclosed in U.S. Pat. No. 4,352,915 (two slurry reactors), U.S. Pat. No. 5,925,448 (two fluidized bed reactors), and U.S. Pat. No. 6,445,642 (loop reactor followed by a gas phase reactor). However, in other embodiments, the first LLDPE polymer may be a multimodal polymer, e.g., LLDPE, made using a slurry polymerization in a loop reactor followed by a gas phase polymerization in a gas phase reactor, as disclosed in EP 2653392 A1.

Before it is coextruded, the first LLDPE composition further comprises a free-radical generator. Examples of free-radical generators include organic peroxides and organic azo compounds. In some embodiments, the free-radical generator is an organic peroxide compound.

In some embodiments, the free-radical generator has a half-life at 220° C. of no more than 200 seconds. For example, some embodiments of the free-radical generator may have a half-life at 220° C. of no more than 175 seconds, 150 seconds, or 125 seconds. Some embodiments of the free-radical generator may have a half-life at 220° C. of at least 30 seconds or at least 45 seconds or at least 60 seconds.

In some embodiments, the free-radical generator may have a molecular weight from 200 to 1000 Daltons (Da). All individual values and subranges of from 200 to 1000 Daltons are included and disclosed herein. For example, in some embodiments, the free-radical generator may have a molecular weight of at least 225 Da or 250 Da. In some embodiments, the free-radical generator may have a molecular weight of at most 1000 Da or at most 700 Da.

In some embodiments, the free radical generator may be a cyclic peroxide. An example of a suitable cyclic peroxide may be represented by the formula:

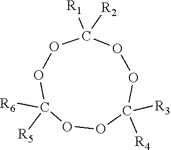

wherein R₁-R₆ are independently hydrogen or an inertly-substituted or unsubstituted C₁-C₂₀ alkyl, C₃-C₂₀ cycloalkyl, C₆-C₂₀ aryl, C₇-C₂₀ aralkyl, or C₇-C₂₀ alkaryl. Representative of the inert-substituents included in R₁-R₆ are hydroxyl, C₁-C₂₀ alkoxy, linear or branched C₁-C₂₀ alkyl, C₆-C₂₀ aryloxy, halogen, ester, carboxyl, nitrile, and amido. In some embodiments, R₁-R₆ are each independently lower alkyls, including, for example, C₁-C₁₀ alkyl, or C₁-C₄ alkyl.

Some of the cyclic peroxides as described herein are commercially available, but otherwise can be made by contacting a ketone with hydrogen peroxide as described in U.S. Pat. No. 3,003,000; Uhlmann, 3^{rd} Ed., Vol. 13, pp. 256-57 (1962); the article, “Studies in Organic Peroxides XXV Preparation, Separation and Identification of Peroxides Derived from Methyl Ethyl Ketone and Hydrogen Peroxide,” Milas, N. A. and Golubovic, A., J. Am. Chem. Soc, Vol. 81, pp. 5824-26 (1959); “Organic Peroxides”, Swern, D. editor, Wiley-Interscience, New York (1970); and Houben-Weyl Methoden der Organische Chemie, El 3, Volume 1, page 736.

In some embodiments, the cyclic peroxide may be 3,6,9-triethyl-3-6-9-trimethyl-1,4,7-triperoxonane, which is commercially available from AkzoNobel under the trade designation TRIGONOX 301. The cyclic peroxide used herein can be liquid, solid, or paste depending on the melting point of the peroxide and the diluent, if any, within which it is carried.

The free-radical generator should be present in an amount suitable to increase the low-shear viscosity of the first LLDPE composition. In some embodiments, the ratio of free-radical generator to first LLDPE composition is from 5 ppmw to 1000 ppmw. All individual values and subranges from 5 to 1000 ppmw are included herein and disclosed herein; for example, the ratio of free-radical generator to the first LLDPE composition may range from a lower limit of 5, 10, 20, 30, 40 or 50 ppmw to an upper limit of 40, 50, 60, 65, 75, 100, 150, 250, 350, 450, 550, 650, 750, 850, 950 or 1000 ppmw. In some embodiments, the weight ratio of free-radical generator to the first LLDPE composition may be in the range of from 5 to 100 ppmw relative to the total amount of polymer, or 5 to 75 ppmw, or 10 to 75 ppmw, or 5 to 50 ppmw, or 10 ppmw to 50 ppmw, or 15 to 35 ppmw, or 20 to 40 ppmw.

In some embodiments, the first LLDPE composition optionally comprises other polyethylene polymers. In some embodiments, any other polymers are LLDPE polymers. In some embodiments, another polymer is a low-density polyethylene.

The first LLDPE polymer makes up at least 85 weight percent of the first LLDPE composition. In some embodiments, the first LLDPE polymer makes up at least 90 weight percent of the first LLDPE composition, or at least 95 weight percent or at least 99 weight percent. In some embodiments, LDPE polymers can make up at least 1 weight percent of the first LLDPE composition, or at least 2 weight percent or at least 3 weight percent. In some embodiments, LDPE polymers make up 0 to 15 weight percent of the first LLDPE composition, or 0 to 10 weight percent or 0 to 5 weight percent or 0 to 3 weight percent or 0 to 1 weight percent or essentially 0 weight percent.

One way that other polymers may be introduced into the first LLDPE composition is if the free radical generator is blended with a carrier polymer to form a masterbatch, as described in PCT Patent Publication 2017/172273 A1. The masterbatch can be blended with the first LLDPE polymer to form the first LLDPE composition and disperse the free-radical generator throughout the first LLDPE polymer. The masterbatch provides better control of free-radical generator concentration and better dispersion.

The carrier polymer may be a low density polyethylene (LDPE), a linear low density polyethylene (LLDPE), a medium density polyethylene (MDPE), a high density polyethylene (HDPE), or combinations thereof. In some embodiments, the carrier polymer is an LLDPE polymer. When the carrier polymer is an LLDPE polymer, it may have the same descriptions, embodiments and examples listed for the first LLDPE polymer, except the presence of vinyl end groups is optional rather than required. In some embodiments, the carrier polymer is an LDPE polymer.

In some embodiments, the masterbatch composition comprises at least 100 ppmw free-radical generator or at least 200 ppmw or at least 300 ppmw or at least 400 ppmw or at least 500 ppmw. In some embodiments, the masterbatch composition comprises at most 4000 ppmw free-radical generator or at most 3000 ppmw or at most 2000 ppmw or at most 1500 ppmw or at most 1000 ppmw.

Depending on the concentration of free-radical generator in the masterbatch composition, the first LLDPE polymer and the masterbatch may be blended at a ratio of 60:40 to 99.9:0.1. All individual values and subranges are included and disclosed herein. For example, in some embodiments, the first LLDPE polymer and the masterbatch may be blended at a ratio of 65:35 to 99.9:0.1, 65:35 to 99.9:0.1, 70:30 to 99.9:0.1, 75:25 to 99.9:0.1, 80:20 to 99.9:0.1, 85:15 to 99.9:0.1, 90:10 to 99.9:0.1, 95:5 to 99.9:0.1, 97:3 to 99.9:0.1, 95:5 to 99:1, or 97:3 to 99:1. The first LLDPE polymer and masterbatch may also be blended such that the amount of masterbatch in the first LLDPE composition ranges from 0.1 to 40 wt. All individual values and subranges are included and disclosed herein. For example, in some embodiments, the first LLDPE polymer and the masterbatch may be blended such that the amount of masterbatch in the first LLDPE composition is at least 0.1 weight percent or at least 0.2 weight percent or at least 0.5 weight percent or at least 1 weight percent or at least 2 weight percent, and in some embodiments the first LLDPE polymer and the masterbatch may be blended such that the amount of masterbatch in the first LLDPE composition is no more than 15 weight percent or no more than 10 weight percent or no more than 5 weight percent or no more than 3 weight percent.

In some embodiments, the first LLDPE composition may contain other additives that are common for LLDPE films, such as plasticizers, flame retardants, antioxidants, acid scavengers, light and heat stabilizers, lubricants, pigments, antistatic agents, slip compounds and thermal stabilizers. In some embodiments, other additives make up no more than 5 weight percent of the first LLDPE composition or no more than 4 weight percent or no more than 3 weight percent or no more than 2 weight percent or no more than 1 weight percent. In some embodiments, other additives make up essentially 0 weight percent of the first LLDPE composition.

In some embodiments herein, the first LLDPE composition comprises no more than 2,000 ppmw of primary antioxidant. All individual values and subranges from 0 to 2,000 ppmw of primary antioxidant are included and disclosed herein. For example, in some embodiments, the first LLDPE composition may comprise from a lower limit of 0, 10, 25, 50, 100, 200, 300, 400, 500, 600, 700, 800, 900, 1000, 1100, 1200, 1300, 1400, 1500, 1600, 1700, 1800, or 1900 ppmw to an upper limit of 15, 30, 50, 75, 100, 150, 250, 350, 450, 550, 650, 750, 850, 950, 1000, 1050, 1150, 1250, 1350, 1450, 1500, 1550, 1650, 1750, 1850, 1950, or 2000 ppmw of primary antioxidant. In other embodiments herein, the first LLDPE composition may comprise at most 250 ppmw, at most 200 ppmw, at most 150 ppmw, at most 100 ppmw, at most 50 ppmw, at most 25 ppmw, or 0 ppmw of primary antioxidant. In further embodiments, the first LLDPE composition may comprise from 10 to 1000 ppmw, from 10 to 500 ppmw, from 500 to 1000 ppmw, from 10 to 300 ppmw, or from 20 to 100 ppmw of primary antioxidant. Primary antioxidants are radical scavengers that are generally organic molecules consisting of hindered phenols or hindered amine derivatives. Examples of primary antioxidants include primary antioxidants that are well known in the polyolefin industry, such as, pentaerythrityl tetrakis(3-(3,5-di-tert-butyl-4-hydroxyphenol)propionate), which is commercially available from BASF under the name of IRGANOX™ 1010, or octadecyl 3-(3,5-di-tert-butyl-4-hydroxyphenyl)propionate, which is commercially available from BASF under the name IRGANOX™ 1076. Secondary antioxidants decompose hydroperoxides and are generally organic molecules consisting of phosphites, phosphonites, or thio compounds. Exemplary secondary antioxidants include tris(2,4-ditert-butylphenyl) phosphite, which is commercially available from BASF under the name IRGAFOS™ 168, or tris(nonylphenyl) phosphite.

### Other Polymer Layer Materials

In some embodiments, the first LLDPE composition is coextruded with a polymer composition to form a multilayer film that contains a primary layer derived from the first LLDPE composition and a second layer derived from the polymer composition. The two layers are adhered directly or indirectly to each other.

The selection of the polymer composition depends on the purpose of the layer that it will form. Common layers in multilayer LLDPE films include heat-seal layers, print layers, stiffness layers, barrier layers and tie layers.

Polymers for heat seal layers are commonly thermoplastic polymers that can readily melt and adhere under heat seal conditions in the form, fill and seal packaging process. These are often referred by those skilled in the art as heat seal polymers. Examples of common heat-seal polymers include LLDPE (made using either Ziegler-Natta catalysts or metallocene catalysts), ethylene-vinyl acetate copolymers and polymer blends thereof. In many embodiments, the heat seal polymer contains a metallocene LLDPE.

In some embodiments, the heat seal polymer has an average density of at least 0.90 g/cm³ or at least 0.91 g/cm³. In some embodiments, the heat seal polymer has an average density of at most 0.94 g/cm³ or at most 0.93 g/cm³ or at most 0.92 g/cm³.

In some embodiments, the heat seal polymer has a melt index (I₂) of at least 0.2 g/10 min or at least 0.5 g/10 min or at least 0.7 g/10 min or at least 1 g/10 min or at least 2 g/10 min.

In some embodiments, the heat seal polymer has a melt index (I₂) of at most 10 g/10 min or at most 5 g/10 min or at most 3 g/10 min.

In some embodiments, the heat seal polymer has a melting temperature of at least 80° C. or at least 85° C. or at least 90° C. or at least 100° C. In some embodiments, the heat seal polymer has a melting temperature of at most 130° C. or at most 125° C. or at most 120° C.

In some embodiments, the heat seal polymer has a seal initiation temperature (for a seal strength of 4N/15 mm) of at least 80° C. or at least 85° C. or at least 90° C. or at least 95° C. In some embodiments, the heat seal polymer has a seal initiation temperature (for a seal strength of 4N/15 mm) of at most 130° C. or at most 120° C. or at most 110° C. or at most 105° C.

In some cases, Ziegler-Natta polyethylenes can have higher density and seal initiation temperatures and lower melt index within the above ranges, whereas metallocene polyethylenes can have lower density and seal initiation temperatures and higher melt index within the above ranges.

In some embodiments, the heat seal polymer has a hot tack strength at 110° C. of at least 0.6 N/15 mm or at least 0.8 N/15 mm or at least 1 N/15 mm or at least 1.5 N/15 mm. There is no maximum desired hot tack strength, but in some embodiments a hot tack strength at 110° C. above 10 N/15 mm or 5 N/15 mm is unnecessary.

Examples of suitable heat seal polymers include enhanced polyethylene polymers that are commercially available under the ELITE™ trademark and certain LLDPE polymers commercially available under the DOWLEX™ trademark.

A print layer would ordinarily be on the surface of the multilayer film, opposite to the heat-seal layer. Polymers may be selected to have a good appearance, such as high gloss, and to provide a good surface for adhesion of ink. Examples of common polymers in the print layer include LLDPE derived from Ziegler-Natta or metallocene catalysts. Common print layer polymers are commercially available under the trademark DOWLEX™ GM 8051, DOWLEX™ TG2085B, DOWLEX™ GM8070, DOWLEX™ 2049, ELITE™ AT 6501 and INNATE™ ST50.

Barrier layers can reduce the migration of gases, moisture and/or flavor elements through a multilayer film. Examples of common barrier polymers include ethylene vinyl alcohol, ethylene vinyl acetate, polyvinylidene chloride, polypropylene, polyamide, polyethylene terephthalate, and polyvinyl chloride. Polymers for the barrier layers are commercially available, such as under the trademarks SARAN™, Eval, Ube nylon-6 and Miramid.

Tie layers can improve the adhesion of different layers in a multilayer film, especially when different layers contain incompatible polymers. Examples of common tie layer polymers include ethylene acrylic acid copolymers and ethylene vinyl acetate copolymers. Examples of common tie layers are commercially available under the trademarks BYNEL™, Plexar, EMAC, Surpass and Novapol.

### Co-Extrusion and Multilayer Film:

The materials named above may be coextruded by known processes to form a multilayer film. Materials can be melted in separate extruders. The molten materials are fed to an extrusion die. The die is designed to extrude each material as one or more discrete and continuous layers in a multilayer film.

In a cast film extrusion, the die is a slot die, and the film is extruded onto a chill roll, quenched, and wound onto a roll.

In a blown film extrusion, the die is a circular die. A gas bubble (such as air or nitrogen) is trapped inside the circular film between the die and a pair of downstream nip rollers. The film passes over the air bubble before it solidifies and is biaxially stretched. The film is cooled, flattened and wound into a roll.

Examples of the coextrusion processes are described in LyondellBasell, A Guide to Polyolefin Film Extrusion, Publication 6047/1004 (available at lyb.com); LyondellBasell, How to Solve Blown Film Problems, Publication 6483/0559 (available at www.lyondellbasell.com; Qenos Pty, Ltd., Film Extrusion and Conversion—Technical Guide (July 2015) (available at qenos.com); Golghate et al., Adopting Best Practices in Blown Film Extrusion Process: Need of the Hour to Control Environmental Burdens, 3(1) International Journal of Industrial Engineering & Technology 63-80 (2013); and Goff et al., The Dynisco Extrusion Processors Handbook, 2^{nd} Edition (available at www.dynisco.com).

In processes of the present invention, the conditions in the extruder for the first LLDPE composition (including the extrusion die) should be suitable to substantially decompose the free radical generator. Necessary conditions may depend on the free radical generator selected and the effectiveness of mixing in the extruder. In some embodiments, the first LLDPE composition achieves a temperature of at least 180° C. or at least 190° C. or at least 200° C. or at least 210° C. or at least 215° C. Generally, the temperature is low enough that the first LLDPE composition is not substantially degraded. In some embodiments the temperature does not exceed 250° C. or 240° C. or 230° C. In some embodiments, the first LLDPE composition maintains the selected temperature for at least 30 second or at least 45 second or at least 60 seconds, and in some embodiments the first LLDPE composition maintains the selected temperature for no more than 15 minutes or no more than 10 minutes or no more than 5 minutes or no more than 3 minutes or no more than 2 minutes. Suitable conditions to decompose the free radical generator are often achieved in extruders used in conventional multilayer film extrusion, so in some embodiments no change in existing procedures is needed.

The product of the coextrusion process is a multilayer film. It comprises at least (1) a primary layer derived from the first LLDPE composition and (2) a second layer, which is derived from the polymer composition and which is adhered directly and indirectly to the primary layer. In some embodiments, the second layer is a heat seal layer containing a heat seal polymer as previously described. The heat seal layer, if present, would generally form one surface of the multilayer film.

In some embodiments, the multilayer film further comprises (3) a third polymer layer, which is adhered directly or indirectly to the primary layer on the opposite side from the second layer. For example, the multilayer film can comprise at least 3 layers which include (1) a primary layer, (2) a heat seal layer adhered directly and indirectly to one side of the primary layer forming one surface of the multilayer film; and (3) another surface layer adhered directly and indirectly to the primary layer on the opposite side from the heat seal layer forming another surface of the multilayer film. In some embodiments, the other surface layer is a print layer as previously described.

In structures of three or more layers, the primary layer is frequently an inner layer rather than a surface layer, and is often called a “core” layer.

In some embodiments, the multilayer film comprises more layers, such as 5, 6, 7, 8 or 9 layers. For example, in addition to the 3 layers previously described, the multilayer film may contain a barrier layer and one or more tie layers to promote adhesion between the barrier layer and the surrounding layers. In some embodiments, the barrier layer and tie layers are inner layers, rather than surface layers.

In some embodiments, the multilayer film has a thickness of at least 10 μm or at least 20 μm or at least 30 μm. In some embodiments, the multilayer film has a thickness of at most 200 μm or at most 150 μm or at most 120 μm or at most 100 μm.

In some embodiments, the primary layer makes up at least 30% of the thickness of the multilayer film or at least 40% or at least 50% or at least 60% or at least 70% or at least 80% or at least 90%. In some embodiments, layers other than the primary layer make up at least 5% of the thickness of the multilayer film, or at least 10% or at least 20% or at least 30%. In some embodiments, the second layer makes up at least 5% of the thickness of the multilayer film, or at least 10% or at least 20%. In some embodiments, a third layer makes up at least 5% of the thickness of the multilayer film, or at least 10% or at least 20%.

The decomposition of the free-radical generator during extrusion can change the properties of the first LLDPE composition in the primary layer. Without intending to be bound by theory, we hypothesize that this change results from a small amount of long chain branching introduced by the free-radical generator. The resulting first LLDPE composition can be referred to as an extruded first LLDPE composition.
In some embodiments, the extruded first LLDPE composition has a weight average molecular weight (Mw_{Abs}) of at least 90,000 Da or at least 110,000 Da or at least 122,000 Da or at least 125,000 Da or at least 130,000 Da. In some embodiments, the extruded first LLDPE composition has a weight average molecular weight (Mw_{Abs}) of at most 200,000 Da or at most 160,000 Da.
In some embodiments, the extruded first LLDPE composition has a molecular weight distribution (Mw_{Abs}/Mn_{Abs}) of at least 4 or at least 4.5 or at least 5. In some embodiments, the extruded first LLDPE composition has a molecular weight distribution (Mw_{Abs}/MnAbs) of at most 7 or at most 6 or at most 5.5.
In some embodiments, the ratio of Mz_{Abs}/Mw_{Abs} for the extruded first LLDPE composition is at least 2.5 or at least 2.9 or at least 3.1 or at least 3.2. In some embodiments, the ratio of Mz_{Abs}/Mw_{Abs} for the extruded first LLDPE composition is at most 5.0 or at most 4.0 or at most 3.5.
In some embodiments, the ratio of Mz_{Abs}/Mw_{Abs} for the extruded first LLDPE composition is at least 5% higher than the of Mz/Mw for the first LLDPE polymer before extrusion or at least 8% or at least 10% or at least 12% or at least 15% or at least 17%. In some embodiments, the ratio of Mz/Mw for the extruded first LLDPE composition is at most 30% higher than the of Mz/Mw for the first LLDPE polymer before extrusion or at most 25% or at most 20%.
In some embodiments, the extruded first LLDPE composition has a complex viscosity (η₁₀) of no more than 6000 Pa-s or no more than 5000 Pa-s or no more than 4900 Pa-s or no more than 4800 Pa-s or no more than 4700 Pa-s, at a temperature of 190° C. and an angular frequency of 10 rad/s. In some embodiments, the extruded first LLDPE composition has a complex viscosity (110) of at least 4500 Pa-s or at least 4700 Pa-s, at a temperature of 190° C. and an angular frequency of 10 rad/s.
In some embodiments, the extruded first LLDPE composition has a complex viscosity (η_{0.1}) of at least 7000 Pa-s or at least 8000 Pa-s or at least 9000 Pa-s or at least 10000 Pa-s, at a temperature of 190° C. and an angular frequency of 0.1 rad/s. In some embodiments, the extruded first LLDPE composition has a complex viscosity (η_{0.1}) of no more than 15000 Pa-s or no more than 12000 Pa-s or no more than 11000 Pa-s, at a temperature of 190° C. and an angular frequency of 0.1 rad/s.
In some embodiments, the extruded first LLDPE composition has a complex viscosity ratio (η_{0.1}/η₁₀) of at least 1.6 or at least 1.7 or more than 1.7 or at least 1.75 or at least 1.8 or at least 1.85 or at least 1.9 or at least 1.95. In some embodiments, the extruded first LLDPE composition has a complex viscosity ratio (η_{0.1}/η₁₀) of no more than 4 or no more than 3 or no more than 2.5.
In some embodiments, the complex viscosity (η_{0.1}) of the extruded first LLDPE composition (at a temperature of 190° C. and an angular frequency of 0.1 rad/s) is at least 5% higher than the complex viscosity of the first LLDPE polymer before extrusion or at least 10% higher or at least 15% higher or at least 20% higher or at least 25% higher or at least 30% higher or at least 35% higher or at least 40% higher. In some embodiments, the complex viscosity (η_{0.1}) of the extruded first LLDPE composition (at a temperature of 190° C. and an angular frequency of 0.1 rad/s) is at most 100% higher than the complex viscosity of the first LLDPE polymer before extrusion or at most 60% higher.
In some embodiments, the complex viscosity ratio (η_{0.1}/η₁₀) of the extruded first LLDPE composition is higher than the complex viscosity ratio of the first LLDPE polymer before extrusion by at least 5% or at least 10% or at least 15% or at least 20%. There is no maximum desirable increase in complex viscosity ratio, but in some embodiments increases over 50% are unnecessary.

In some embodiments, multilayer films of the present invention have a secant modulus at 2% of at least 140 MPa or at least 150 MPa or at least 160 MPa or at least 170 MPa. In some embodiments, multilayer films of the present invention have a secant modulus at 2% of at most 250 MPa, or at most 200 MPa or at most 180 MPa.

In some embodiments, multilayer films of the present invention have a puncture force of at least 1.5 N/μm thickness of the film or at least 1.55 N/μm or at least 1.60 N/μm or at least 1.65 N/μm. In some embodiments, multilayer films of the present invention have a puncture force of at most 5 N/μm or at most 3 N/μm. In some embodiments, the puncture force of inventive multilayer films is at least 5% higher than the puncture force of a comparable film in which the primary layer contains a comparable polymer extruded without free radical generator, or at least 10% higher or at least 12% higher.

In some embodiments, multilayer films of the present invention have a dart drop resistance of at least 5 g/μm thickness of the film or at least 6 g/μm or at least 6.2 g/μm or at least 6.5 g/μm or at least 7 g/μm or at least 7.5 g/μm. In some embodiments, multilayer films of the present invention have a dart drop resistance of at most 20 g/μm or at most 10 g/μm. In some embodiments, the dart drop resistance of inventive multilayer films is at least 5% higher than the dart drop resistance of a comparable film in which the primary layer contains a comparable polymer extruded without free radical generator, or at least 10% higher or at least 15% higher or at least 20% higher or at least 25% higher.

In some embodiments, multilayer films of the present invention have a Haze of at most 25% or at most 22% or at most 20% or at most 18%. There is no minimum desired level of haze (0%), but in many embodiments haze below 10% is unnecessary.

### Use of the Multilayer Film

Multilayer films of the present invention can be used in conventional form, fill and seal processes, such as a vertical form, fill and seal (VFFS) process or a horizontal form, fill and seal (HFFS) process. Examples of suitable processes are described in U.S. Pat. Nos. 4,757,668; 4,807,420; 5,279,098; 5,540,035 and 5,533,322 and in the publication Vertical Form Fill and Seal, published by Rockwell Automation Inc and available on their website www.rockwellautomation.com. Suitable equipment is commercially available.

The multilayer films of the present invention having an extruded primary layer can have improved packaging properties, as compared with a similar package that contains unextruded polymer. In some embodiments, the modification substantially increases the bag drop strength of a package made using the multilayer film. In some embodiments, the modification substantially increases the strength of heat seals made using the multilayer film at high temperatures. In some embodiments, the film can provide a seal strength within 10% (or 5%) of the maximum strength over a range of 5° C. or 10° C. or 15° C. or 20° C., when sealed and tested as described in the Test Methods. The broad range of effective sealing temperature is valuable because a single film can provide strong seals on a variety of equipment operating at different temperatures.

The invention is further illustrated by the following examples, which illustrate specific embodiments of the invention but do not limit the broad scope of the invention.

### EXAMPLES

### Test Methods

Parameters described in this application can be measured using the following measurements:

| Parameter | Test |
|---|---|
| Density | ASTM D792, Method B. |
| Melt Index | ASTM D1238 at 190° C., 2.16 kg. |
| Comonomer Content/ | 13C NMR analysis as described in U.S. Pat. No. |
| Short Chain Branches | 7,498,282. |
| per 1000 C | |
| Polymer Melting | ASTM D3418 |
| Temperature | |
| Seal Initiation | The Seal Initiation Temperature (SIT) is the |
| Temperature | temperature at which a given seal strength (4N/15 |
| | mm using method 2) is attained. Seal strength is |
| | measured as set out below. |
| Secant Modulus | ASTM D882 |
| Puncture Resistance | ASTM D5748, 250 mm/min |
| Dart Drop Resistance | ASTM D1709 - Method A |
| Seal Strength | Evaluated using ASTM F-88 on controlled |
| | laboratory seals made according to ASTM F2029 |
| Hot Tack Strength | ASTM F1921 |
| Haze | ASTM 1003 |

Molecular Weight Molecular weight/molecular weight distribution and a Mark-Houwink plot for branching structure analysis are measured using Triple Detector Gel Permeation Chromatography. The processes and equations utilized are described in U.S. Pat. No. 8,871,887. U.S. Pat. No. 8,871,887 is incorporated by reference. For the Gel Permeation Chromatography (GPC) processes (Conventional GPC, Light Scattering (LS) GPC, Viscometry GPC and gpcBR), a Triple Detector Gel Permeation Chromatography (3D-GPC or TDGPC) system is utilized. This system includes a Robotic Assistant Delivery (RAD) high temperature GPC system [other suitable high temperature GPC instruments include Waters (Milford, Mass.) model 150C High Temperature Chromatograph; Polymer Laboratories (Shropshire, UK) Model 210 and Model 220; and Polymer Char GPC-IR (Valencia, Spain)], equipped with a Precision Detectors (Amherst, Mass.) 2-angle laser light scattering (LS) detector Model 2040, an IR4 infra-red detector from Polymer ChAR (Valencia, Spain), and a 4-capillary solution viscometer (DP) (other suitable viscometers include Viscotek (Houston, Tex.) 150R 4-capillary solution viscometer (DP)). A GPC with these latter two independent detectors and at least one of the former detectors can be referred to as “3D-GPC” or “TDGPC,” while the term “GPC” alone generally refers to conventional GPC. Data collection is performed using software, e.g., Polymer Char GPC-IR. The system is also equipped with an on-line solvent degassing device, e.g., from Polymer Laboratories.

Eluent from the GPC column set flows through each detector arranged in series, in the following order: LS detector, IR4 detector, then DP detector. The systematic approach for the determination of multi-detector offsets is performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)). Olexis LS columns is used. The sample carousel compartment is operated at 140° C. and the column compartment is operated at 150° C. The samples are prepared at a concentration of 0.1 grams of polymer in 50 milliliters of solvent. The chromatographic solvent and the sample preparation solvent is 1,2,4-trichlorobenzene (TCB) containing 200 ppmw of 2,6-di-tert-butyl-4methylphenol (BHT). The solvent is sparged with nitrogen. The polymer samples are gently stirred at 160° C. for four hours. The injection volume is 200 microliters. The flow rate through the GPC is set at 1 ml/minute.

For Conventional GPC, the IR4 detector is used, and the GPC column set is calibrated by running 21 narrow molecular weight distribution polystyrene standards. The molecular weight of the standards ranged from 580 g/mol to 8,400,000 g/mol, and the standards are contained in six “cocktail” mixtures. Each standard mixture had at least a decade of separation between individual molecular weights. The polystyrene standards are prepared at 0.025 g in 50 mL of solvent for molecular weights equal to, or greater than, 1,000,000 g/mol, and at 0.05 g in 50 mL of solvent for molecular weights less than 1,000,000 g/mol. The polystyrene standards are dissolved at 80° C., with gentle agitation, for 30 minutes. The number average molecular weight, the weight average molecular weight, and the z-average molecular weight are calculated from equations, e.g., as described in U.S. Pat. No. 8,871,887.

For the LS GPC, the Precision Detector PDI2040 detector Model 2040 is used. For 3D-GPC, absolute weight average molecular weight is calculated from equations, e.g., as described in U.S. Pat. No. 8,871,887. The gpcBR branching index is determined by calibrating the light scattering, viscosity, and concentration detector and subtracting the baselines. Integration windows are set for integration of the low molecular weight retention volume range in the light scattering and viscometer chromatograms that indicated the presence of detectable polymer from the refractive index chromatogram. Linear polyethylene standards are used to establish polyethylene and polystyrene Mark-Houwink constants. The constants are used to construct two linear references, conventional calibrations for polyethylene molecular weight and polyethylene intrinsic viscosity as a function of elution volume, e.g., as described in U.S. Pat. No. 8,871,887. To determine the gpcBR branching index, the light scattering elution area for the sample polymer is used to determine the molecular weight of the sample. Analysis is performed using the final Mark-Houwink constants, e.g., as described in U.S. Pat. No. 8,871,887.

Vinyl Unsaturation Samples are prepared by adding ˜130 mg of sample to 3.25 g of 50/50 by weight Tetrachlorethane-d2/Perchloroethylene with 0.001 M Cr(AcAc)3 in a Norell 1001-7 10 mm NMR tube. The samples are purged by bubbling nitrogen through the solvent via a pipette inserted into the tube for approximately 5 minutes, capped, sealed with Teflon tape and then soaked at room temperature overnight to facilitate sample dissolution. The samples are heated and vortexed at 115° C. to ensure homogeneity. 1H NMR is performed on a Bruker AVANCE 400 MHz spectrometer equipped with a Bruker Dual DUL high-temperature CryoProbe and a sample temperature of 120° C. Two experiments are run to obtain spectra, a control spectrum to quantitate the total polymer protons, and a double presaturation experiment, which suppresses the intense polymer backbone peaks and enables high sensitivity spectra for quantitation of the end-groups. The control is run with ZG pulse, 4 scans, AQ 1.64 s, D1 (relaxation delay) 14 s. The double presaturation experiment is run with a modified pulse sequence, 100 scans, DS 4, AQ 1.64 s, D1 (presaturation time) Is, D13 (relaxation delay) 13 s. The region between 4.95 to 5.15 ppmw is integrated to determine vinyl content.

### Polymer Viscosity

Samples are compression molded at 190° C., for 6.5 minutes at pressure of 25000 lbs. in air, and the plaques are subsequently allowed to cool down on lab bench. Plaque thickness is ˜3 mm. Constant temperature frequency sweep measurements are performed on an ARES strain controlled parallel plate rheometer (TA Instruments) equipped with 25 mm parallel plates, under a nitrogen purge. For each measurement, the rheometer is thermally equilibrated for at least 30 minutes prior to zeroing the gap. The sample is placed on the plate and allowed to melt for five minutes at 190° C. The plates are then closed to 2 mm, the sample trimmed, and then the test is started. The method had an additional five minute delay built in, to allow for temperature equilibrium. The experiments are performed at 190° C. over a frequency range of 0.1-100 rad/s at five points per decade interval. The strain amplitude is constant at 10%. The stress response is analyzed in terms of amplitude and phase, from which the storage modulus (G′), loss modulus (G″), complex modulus (G*), dynamic complex viscosity (η*), and tan (δ) or tan delta are calculated.

### Master Batch:

A masterbatch (MB-1) is made that contains 1000 ppmw of Trigonox 301 free radical generator dispersed in DOW™ LDPE 4016. The masterbatch is produced on a ZSK-26 mm Coperian Co-rotating Twin Screw Extruder (TSE) under a nitrogen atmosphere. The extruder is an 11 barrel, 44 L/D electrically heated and water cooled machine with a maximum RPM of 1200. The LDPE is fed into barrel 1 via a K-Tron KQX gravimetric feeder at a rate of 60 lbs./hr. A 1:1 solution of free radical generator and mineral oil is injected via a 1000D ISCO syringe pump and back pressure injector valve into barrel 9 to give a target concentration of 1000 ppmw of active free radical generator. The polymer melt is then fed through a transition piece, a polymer divert valve, and into the underwater 2 hole, 0.110 diameter die producing pellets at ˜37 count/g.

### Multilayer Films

Example 1: A five layer film is coextruded on a Reifenhauser extruder with a Blow-Up Ratio (B.U.R.) of 2.5, a temperature range of 185° C. to 200° C., a thickness of 32 μm and an output rate of about 450 kg/h. The film contains DOWLEX™ TG 2085B linear low-density polyethylene, MB-1 masterbatch and MB901250BX processing aid from Ampacet. Each layer makes up 20% of the film by volume. The content of each layer is shown in Table 2.

TABLE 2

| | LLDPE | MB-1 | Processing Aid |
|---|---|---|---|
| Layer | (wt %) | (wt %) | (wt %) |
| 1 | 95 | 3 | 2 |
| 2 | 97 | 3 | — |
| 3 | 97 | 3 | — |
| 4 | 97 | 3 | — |
| 5 | 95 | 3 | 2 |

Example 2: A three layer film is coextruded using a Collin medical line extruder with an 80 mm die, a die gap of 1.8 mm, a B.U.R of 2.5:1, a thickness of 100 m and an output rate of about 1.50 kg/h. The temperature in the die is 230° C. The film contains DOWLEX™ GM8051 linear low-density polyethylene, MB-1 and MB901250BX processing aid from Ampacet. The content of each layer is shown in Table 3.

Example 3: A three layer film is coextruded as described in Example 2 with a higher level of MB-1 masterbatch. The content of each layer is shown in Table 3.

TABLE 3

| | | | | |
|---|---|---|---|---|
| | Layer Thickness | LLDPE | MB-1 | Processing Aid |
| Layer | (%) | (wt %) | (wt %) | (wt %) |

Example 2

| | | | | |
|---|---|---|---|---|
| 1 | 20 | 99 | — | 1 |
| 2 | 60 | 98 | 2 | — |
| 3 | 20 | 99 | — | 1 |

Example 3

| | | | | |
|---|---|---|---|---|
| 1 | 20 | 99 | — | 1 |
| 2 | 60 | 96 | 4 | — |
| 3 | 20 | 99 | — | 1 |

Comparative Example 1: A five layer film is coextruded as described in Example 1, except that in place of MB-1 master batch the film contains EB853/72 LDPE polymer (commercially available from Braskem), in the proportions shown in Table 4.

TABLE 4

| | LLDPE | LDPE | Processing Aid |
|---|---|---|---|
| Layer | (wt %) | (wt %) | (wt %) |
| 1 | 89 | 10 | 1 |
| 2 | 90 | 10 | — |
| 3 | 90 | 10 | — |
| 4 | 90 | 10 | — |
| 5 | 89 | 10 | 1 |

Comparative Example 2: A three layer film is coextruded as described in Example 2, except that no MB-1 masterbatch is used and the die temperature is 235° C. The proportions of components are shown in Table 5.

TABLE 5

| | Layer Thickness | LLDPE | Processing Aid |
|---|---|---|---|
| Layer | (%) | (wt %) | (wt %) |
| 1 | 20 | 99 | 1 |
| 2 | 60 | 100 | — |
| 3 | 20 | 99 | 1 |

### Testing

The mechanical properties of the five layer film from Example 1 and the five layer film from Comparative 1 are measured using the procedures in the Test Methods. The results are shown in Table 6.

TABLE 6

| | Inventive 1 | | Comparative 1 | |
|---|---|---|---|---|
| Measurement | Measurement | St Dev | Measurement | St. Dev |
| Sec Modulus | 185.1 | 12.8 | 192.6 | 8.2 |
| (MD) | | | | |
| Sec Modulus | 231.3 | 14.6 | 229.9 | 8.9 |
| (CD) | | | | |

The properties of the three layer films and their compositions from Example 2 and 3 and the three layer film and its compositions from Comparative 2 are measured using the procedures in the Test Methods. The results are shown in Table 7.

TABLE 7

| | Inventive 2 | Inventive 3 | Comparative 2 |
|---|---|---|---|
| Complex Viscosity @ 0.1 | 9232 | 10764 | 7598 |
| rad/s (η_{0.1}) (Pa-s) | | | |
| Complex Viscosity @ 10 | 4928 | 5403 | 4541 |
| rad/s (η₁₀) (Pa-s) | | | |
| Complex Viscosity Ratio | 1.87 | 1.99 | 1.67 |
| (η_{0.1}/η₁₀) | | | |
| Mn_{Abs} (Da) | 27129 | 28944 | 30334 |
| Mw_{Abs} (Da) | 127722 | 132495 | 121869 |
| Mz_{Abs} (Da) | 404265 | 439673 | 344649 |
| Mz/Mw_{Abs} | 3.17 | 3.32 | 2.83 |
| Sec Modulus/Std. Deviation | 158/9.5 | 152/11.8 | 162/7 |
| @2% (MD) (MPa) | | | |
| Sec Modulus/Std. Deviation | 164/11.5 | 160/5.2 | 170/13.5 |
| @2% (CD) (MPa) | | | |
| Puncture Force/Std. | 168/8.4 | 161/7.7 | 147/8.2 |
| Deviation (N) | | | |
| Dart Drop (g) | 626 | 755 | 596 |
| Haze (%) | 18 | 17 | 19 |

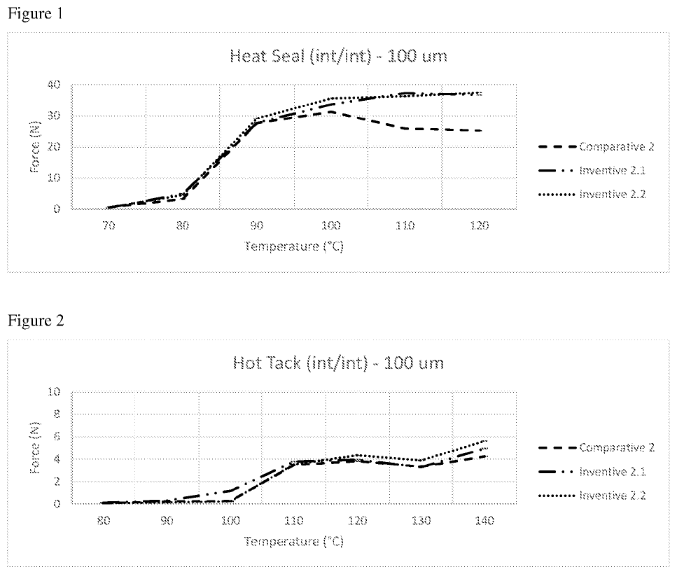

A number of heat seals are made at increasing temperatures using the multilayer films made in Inventive Example 2, Inventive Example 3 and Comparative Example 2 and using the seal procedure in ASTM F2029. The seals are permitted to cool for 40 hours, and then seal strength is tested using the procedures in the test methods. The results are shown in Table 8 and FIG. 1. (In FIG. 1, Inventive Example 2 is called “Inventive 2.1” and Inventive Example 3 is called “Inventive 2.2.”) The results show that the inventive films maintain strong seals across a broad range of sealing temperatures, whereas the seals using the comparative film are strong in only a narrow temperature range and seal strength declines when the temperature exceeds the optimum temperature.

TABLE 8

| Heat Seal | Seal Strength (N) | | |
|---|---|---|---|
| Temperature (° C.) | Comparative 2 | Inventive 2 | Inventive 3 |
| 70 | 0.55 | 0.45 | 0.56 |
| 80 | 3.29 | 4.90 | 4.5 |
| 90 | 27.71 | 27.80 | 29.17 |
| 100 | 31.33 | 33.63 | 35.60 |
| 110 | 25.91 | 37.33 | 36.30 |
| 120 | 25.27 | 36.73 | 37.49 |

The hot tack strength of seals is tested at increasing temperatures using the multilayer films made in Inventive Example 2, Inventive Example 3 and Comparative Example 2 and using the hot tack test listed in the test methods. The results are shown in Table 9 and FIG. 2. (In FIG. 2, Inventive Example 2 is called “Inventive 2.1” and Inventive Example 3 is called “Inventive 2.2.”

TABLE 9

| Heat Seal | | | |
|---|---|---|---|
| Temperature | Hot Tack Seal Strength (N) | | |
| (° C.) | Comparative 2 | Inventive 2 (2.1) | Inventive 3 (2.2) |
| 80 | 0.09 | 0.14 | 0.08 |
| 90 | 0.24 | 0.32 | 0.15 |
| 100 | 0.28 | 1.16 | 0.24 |
| 110 | 3.49 | 3.80 | 3.54 |
| 120 | 3.84 | 3.96 | 4.35 |
| 130 | 3.34 | 3.29 | 3.90 |
| 140 | 4.26 | 4.96 | 5.62 |

1. A multilayer film comprising:
(a) A primary layer comprising an extruded first LLDPE composition that comprises at least 85 weight percent of a first LLDPE polymer, wherein the extruded first LLDPE composition has (1) a complex viscosity ratio (η_{0.1}/η₁₀) of at least 1.7, for complex viscosity measured at 190° C. and an angular frequency of 0.1 rad/s and at 10 rad/s; and (2) a ratio (Mz_{Abs}/Mw_{Abs}) from 2.9 to 4.0; and;
(b) A second layer comprising a polymer composition.

2. The multilayer film of claim 1, wherein the second layer comprises a heat seal polymer.

3. The multilayer film claim 1, that further comprises: (c) a third layer of polymer adhered directly or indirectly to the primary layer opposite the second layer.

4. The multilayer film claim 1, wherein the extruded first LLDPE composition has a complex viscosity ratio (η_{0.1}/η₁₀) of at least 1.8, for complex viscosity measured at 190° C. and an angular frequency of 0.1 rad/s and at 10 rad/s.

5. The multilayer film of claim 1, wherein the extruded first LLDPE composition has a complex viscosity ratio (η_{0.1}/η₁₀) of at least 1.9, for complex viscosity measured at 190° C. and an angular frequency of 0.1 rad/s and at 10 rad/s.

6. The multilayer film of claim 1, wherein the extruded first LLDPE composition has a complex viscosity (η_{0.1}) of at least 8000 Pa-s, for complex viscosity measured at 190° C. and an angular frequency of 0.1 rad/s.

7. The multilayer film of claim 1, wherein the extruded first LLDPE composition has a complex viscosity (η_{0.1}) of at least 9000 Pa-s, for complex viscosity measured at 190° C. and an angular frequency of 0.1 rad/s.

8. The multilayer film of claim 1, wherein the extruded first LLDPE composition has a complex viscosity (η₁₀) of at most 5000 Pa-s, for complex viscosity measured at 190° C. and an angular frequency of 10 rad/s.

9. The multilayer film of claim 1, wherein the film has a puncture force of at least 1.60 N/μm of film thickness as measured by ASTM D5748 at 250 mm/min.

10. The multilayer film of claim 1, wherein film has a dart drop resistance of at least 6 g/μm of film thickness as measured by ASTM D17-9—Method A.

11. A process to make the multilayer film of claim 1 comprising the steps of (1) melting in separate extruders (a) a first LLDPE composition and (b) a polymer composition; and (2) coextruding the first LLDPE composition and the polymer composition under conditions suitable to form a multilayer film comprising a primary layer comprising an extruded first LLDPE composition derived from the first LLDPE composition and a second layer comprising the polymer composition, and wherein:
(a) prior to extrusion, the first LLDPE composition comprises (i) at least 85 weight percent of a first LLDPE polymer that comprises at least 0.20 vinyl groups per 1000 carbon atoms; and (ii) from 5 ppmw to 1000 ppmw of a free-radical generator; and
(b) conditions in the extruder are suitable to substantially decompose the free-radical generator.

12. The process of claim 11, wherein the free-radical generator is a cyclic peroxide.

13. The process of claim 11 wherein, before extrusion, the first LLDPE composition comprises from 10 to 100 ppmw free-radical generator.

14. The process of claim 11 wherein, before extrusion, the first LLDPE composition comprises (1) a first LLDPE polymer and (2) a masterbatch that contains a carrier polymer which is an LLDPE polymer or an LDPE polymer and from 10 ppmw to 1000 ppmw of the free-radical generator.

15. The process of claim 11, wherein the extruded first LLDPE composition in the multilayer film has a complex viscosity ratio (η_{0.1}/η₁₀) that is at least 10 percent higher than the complex viscosity ratio for the first LLDPE polymer before extrusion.
